(19) United States
(12) Patent Application Publication
(10) Pub. No.: US 2026/0367230 A1
(43) Pub. Date: Nov. 19, 2026

(54) DUAL-FREQUENCY TEMPERATURE AND WIND MEASUREMENT SYSTEM AND METHOD FOR HELIUM LASER RADAR BASED ON FIZEAU INTERFEROMETER

(71) Applicant: University of Science and Technology of China, Anhui (CN)

(72) Inventors: Ruocan Zhao, Hefei (CN); Yingyu Liu, Hefei (CN); Xianghui Xue, Hefei (CN); Jiaxin Lan, Hefei (CN); Zhenwei Liu, Hefei (CN); Tingdi Chen, Hefei (CN); Xiankang Dou, Hefei (CN)

(21) Appl. No.: 19/133,641

(22) PCT Filed: Jan. 13, 2023
(86) PCT No.: PCT/CN2023/072058

§ 371 Date: May 28, 2025

(30) Foreign Application Priority Data
Dec. 2, 2022 (CN) 202211544782.6

(51) Int. Cl. G01S 7/483; G01S 17/88

(52) U.S. Cl. CPC G01S 7/483; G01S 17/88

(57) ABSTRACT

A dual-frequency temperature and wind measurement system for a helium laser radar based on a Fizeau interferometer is provided, including: an emitting system, including: at least two laser devices configured to emit pulsed lasers with different frequencies to area to be measured; a receiving system, including: a telescope configured to receive an echo signal having metastable helium scattering information from area to be measured, a filter configured to perform a first-stage filtering process on the echo signal having metastable helium scattering information received by the telescope, a Fizeau interferometer configured to perform a second-stage filtering process on the echo signal having metastable helium scattering information processed by filter, and a detector configured to receive a scattering echo signal processed by the Fizeau interferometer; and a data processing system configured to process the echo signal received by the detector to obtain a wind speed and temperature of area to be measured.

### CROSS REFERENCE TO RELATED APPLICATION

This application entitled “DUAL-FREQUENCY TEMPERATURE AND WIND MEASUREMENT SYSTEM AND METHOD FOR HELIUM LASER RADAR BASED ON FIZEAU INTERFEROMETER”, which is incorporated herein by reference in its entirety which claims priority to Chinese Application No. 202211544782.6, filed on Dec. 2, 2022, incorporated herein by reference in their entirety.

### TECHNICAL FIELD

The present disclosure pertains to a technical field of laser radar, and in particular relates to a dual-frequency temperature and wind measurement system and method for a helium laser radar based on a Fizeau interferometer.

### BACKGROUND

The atmospheric temperature and wind speed of the thermosphere are important parameters for studying thermodynamic and kinetic processes related to the thermosphere. However, the density of neutral atmospheric particles in this altitude range is too low, making it extremely difficult to measure the density, temperature and wind profile of the thermosphere from the ground. In the past, scientists mostly used sounding rockets, satellites, and other spacecraft to measure the thermosphere. However, sounding rockets are expensive and cannot be used for long-term continuous sounding, and satellites have low spatial resolution and cannot obtain long-term uninterrupted observations of specific areas.

With the development of laser radar technology, resonant fluorescence laser radar has gradually become one of the common means of thermosphere detection. Compared with traditional spacecraft measurement means, laser radar can provide continuous data of the thermosphere with a high spatio-temporal resolution. The traditional three-frequency temperature and wind measurement means has been maturely and stably applied in sodium resonance fluorescence laser radar. Compared with sodium laser radar, helium laser radar has a high observation altitude and weak signal. Moreover, the method of achieving temperature and wind measurement by using one transmitter to alternately emit laser with three frequencies requires rapid switching between the laser frequencies and alternating emission of laser. This corresponds to reducing the energy by one third in both the frequency domain and the time domain. Therefore, it is not conducive to obtaining a good signal-to-noise ratio. On this basis, it is an urgent technical problem to develop a more optimized temperature and wind measurement method.

### SUMMARY

According to a first aspect of the present disclosure, there is provided a dual-frequency temperature measurement and wind measurement system for a helium laser radar based on a Fizeau interferometer. A dual-frequency temperature and wind measurement may be achieved by introducing at least two laser devices into an emitting system, introducing a new-typed Fizeau interferometer into a receiving system and collecting metastable helium scattering information in an area to be measured. This not only overcomes the technical defects in the related technologies, but also provides a new research direction for the subsequent study of temperature and wind measurement.

In order to achieve the above objective, a first aspect of the present disclosure provides a dual-frequency temperature and wind measurement system for a helium laser radar based on a Fizeau interferometer. The system includes: an emitting system, including: at least two laser devices configured to emit pulsed lasers with different frequencies to an area to be measured; a receiving system, including: a telescope configured to receive an echo signal having metastable helium scattering information from the area to be measured, a filter configured to perform a first-stage filtering process on the echo signal having metastable helium scattering information received by the telescope, a Fizeau interferometer configured to perform a second-stage filtering process on the echo signal having metastable helium scattering information processed by the filter, and a detector configured to receive a scattering echo signal processed by the Fizeau interferometer, in which the echo signal processed by the Fizeau interferometer is represented by a measurement spectrum, the measurement spectrum is a convolution of a scattering spectrum and a transmittance function of the Fizeau interferometer, and the scattering spectrum is a spectral data of the echo signal having metastable helium scattering information; and a data processing system configured to process an echo signal spectrum received by the detector to obtain a wind speed and temperature of the area to be measured, in which the wind speed and temperature of the area to be measured are determined according to a result of a linear interpolation comparison between the echo signal spectrum of the lasers and an echo signal spectrum library obtained by simulation, and the echo signal spectrum of the lasers is a deconvolution of the measurement spectrum and the transmittance function of the Fizeau interferometer.

According to the embodiments of the present disclosure, the at least two laser devices included in the emitting system includes: a first tunable continuous laser device and a second tunable continuous laser device configured to generate stable and continuous seed lasers; and a first pulse laser device and a second pulse laser device configured to perform an optical amplification on the seed lasers and emit the seed lasers to the area to be measured. The first pulse laser device and the second pulse laser device transmit a part of the emitted lasers after the optical amplification to a first wavelength meter and a second wavelength meter to monitor frequencies of the emitted lasers in real time using the first wavelength meter and the second wavelength meter, and feedback the frequencies to the first tunable continuous laser device and the second tunable continuous laser device to achieve frequency locking of the emitted lasers.

According to the embodiments of the present disclosure, the first tunable continuous laser device and the second tunable continuous laser device are the same in structure, the first pulse laser device and the second pulse laser device are the same in structure, and the first wavelength meter and the second wavelength meter are the same in structure.

According to the embodiments of the present disclosure, the at least two laser devices emit the lasers vertically upward.

A second aspect of the present disclosure provides a dual-frequency temperature and wind measurement method for a helium laser radar based on a Fizeau interferometer applied to the dual-frequency temperature and wind measurement system for a helium laser radar based on a Fizeau interferometer according to any one of the above embodiments. The method includes: performing simulation to obtain an echo signal spectrum database according to a preset laser emission information and a plurality of corresponding temperature and wind speed information within a certain preset temperature and wind speed range, in which the preset laser emission information is frequency information of lasers to be emitted corresponding to the at least two laser devices; emitting, using the at least two laser devices, pulsed lasers with different frequencies to an area to be measured; receiving, using the telescope, the echo signal having metastable helium scattering information from the area to be measured; sequentially performing, using the filter and the Fizeau interferometer, a two-stage filtering process on the echo signal having metastable helium scattering information received by the telescope, and transmitting the echo signal processed to an optical path corresponding to the receiving system; receiving, by the detector, the echo signal from the optical path of the receiving system, in which the echo signal in the optical path of the receiving system is represented by a measurement spectrum, and the measurement spectrum is a convolution of a scattering spectrum and a transmittance function of the Fizeau interferometer; performing a deconvolution process on the measurement spectrum and the transmittance function of the Fizeau interferometer to obtain an echo signal spectrum of the lasers; and performing a linear interpolation comparison between the echo signal spectrum of the lasers and the echo signal spectrum database to determine a closest set of data in the echo signal spectrum of the lasers as a temperature and wind speed of the area to be measured.

According to the embodiments of the present disclosure, the emitting, using the at least two laser devices, pulsed lasers with different frequencies to an area to be measured includes: generating the stable and continuous seed lasers using the first tunable continuous laser device and the second tunable continuous laser device; and performing an optical amplification on the seed lasers and emitting the seed lasers to the area to be measured using the first pulse laser device and the second pulse laser device. After the optical amplification is performed on the seed lasers using the first pulse laser device and the second pulse laser device, frequencies of a part of the emitted lasers received are monitored in real time using the first wavelength meter and the second wavelength meter, and fed back to the first tunable continuous laser device and the second tunable continuous laser device to achieve frequency locking of the emitted lasers.

According to the embodiments of the present disclosure, the at least two laser devices emit two pulsed lasers with different frequencies to the area to be measured, so that four echo signals having metastable helium scattering information of different frequencies are obtainable.

A third aspect of the present disclosure provides a determination method for parameters of a Fizeau interferometer applied to the dual-frequency temperature and wind measurement system for a helium laser radar based on a Fizeau interferometer according to any one of the above embodiments. The method includes: acquiring a plurality of attribute information of an initial Fizeau interferometer, in which the plurality of attribute information includes: a set consisting of a plurality of full widths at half maximum of the initial Fizeau interferometer, a set consisting of a plurality of free spectral ranges, and an angle of incidence of the echo signal having metastable helium scattering information processed by the filter to the initial Fizeau interferometer; traversing the set consisting of a plurality of full widths at half maximum and the set consisting of a plurality of free spectral ranges based on the echo signal spectrum library obtained by simulation, to determine a target full width at half maximum and a target free spectral range; determining a target fine structure constant of the Fizeau interferometer according to the target full width at half maximum and the target free spectral range; determining a target reflectivity of the Fizeau interferometer according to the target fine structure constant; determining a target average cavity length of the Fizeau interferometer according to a wavelength corresponding to the target free spectral range; and determining a target wedge angle of the Fizeau interferometer according to the target average cavity length, in which the target wedge angle is an included angle between two flat plates of the Fizeau interferometer, and the target wedge angle is used to adjust a width of an interference fringe of the Fizeau interferometer.

According to the embodiments of the present disclosure, the target fine structure constant of the Fizeau interferometer and the target reflectivity of the Fizeau interferometer (10) are obtained by calculation through formula (1):

$$F = \frac{FSR}{FWHM} = \frac{π \sqrt{R}}{1 - R} . \qquad ( 1 )$$

In formula (1), F represents the target fine structure constant of the Fizeau interferometer, FSR represents the target free spectral range, FWHM represents the target full width at half maximum, and R represents the target reflectivity of the Fizeau interferometer.

According to the embodiments of the present disclosure, the target average cavity length and the target wedge angle of the Fizeau interferometer are obtained by calculation through formula (2):

$${L}_{0} = \frac{{λ}^{2}}{2 n {λ}_{FSR}} = \frac{λ}{2 α} . \qquad ( 2 )$$

In formula (2), L₀ represents the target average cavity length of the Fizeau interferometer, n represents a refractive index of a medium, λ represents a wavelength of the emitted laser, λ_{FSR} represents the wavelength corresponding to the target free spectral range, and α represents the target wedge angle of the Fizeau interferometer.

According to the embodiments of the present disclosure, by introducing at least two laser devices in the emitting system, two pulsed lasers with different frequencies are ensured to be emitted simultaneously. This overcomes the defects caused by the temperature and wind measurement method by which three frequencies are switched alternately and lasers with three frequencies are emitted using three laser devices in the related technologies. This dual-frequency emitting system may not only save the time of traditional alternate laser emission, but may also reduce the complexity and maintenance difficulty of a laser radar.

According to the embodiments of the present disclosure, by reforming some modules, i.e., introducing a new-typed Fizeau interferometer into the receiving system to replace the traditional F—P etalon, linear fringes that may replace annular fringes may be generated, and the position and shape changes of linear fringes may be detected directly with a linear detector without frequency scanning. The new-typed receiving system may not only save the frequency scanning time and accumulate photon signals continuously, but also greatly simplify the data processing method.

According to the embodiments of the present disclosure, helium atoms are one of the main atmospheric components above 200 km. After physical processes such as photoelectron excitation, metastable helium [He(2³S)] that is more stable and has stronger fluorescence may be produced. Therefore, compared with the temperature and wind measurement using sodium resonance fluorescence laser radar in the related technologies, the temperature and wind measurement by collecting metastable helium scattering information in the area to be measured may provide a new research direction for subsequent researches on temperature and wind measurement, and also fill the theoretical gap in the helium laser radar for temperature and wind measurement. Therefore, this enables a more comprehensive observation and research on the thermospheric atmospheric physical processes and multi-sphere coupling mechanisms.

### BRIEF DESCRIPTION OF THE DRAWINGS

FIG. 1 schematically illustrates a block diagram of a dual-frequency temperature and wind measurement system for a helium laser radar based on a Fizeau interferometer according to the embodiments of the present disclosure.

FIG. 2 schematically illustrates a schematic diagram of the dual-frequency temperature and wind measurement system for a helium laser radar based on a Fizeau interferometer according to the embodiments of the present disclosure.

FIG. 3 schematically illustrates curve charts of backscattering cross sections of metastable helium corresponding to three radiation lines around 1083 nm changing with wavelength according to the embodiments of the present disclosure.

FIG. 4 schematically illustrates a flow chart of a dual-frequency temperature and wind measurement method for a helium laser radar based on a Fizeau interferometer according to embodiments of the present disclosure.

FIG. 5 schematically illustrates curve charts of backscattering cross sections changing with temperature and wind speed according to the embodiments of the present disclosure.

FIG. 6 schematically illustrates two groups of data examples in an echo signal spectrum database according to the embodiments of the present disclosure.

FIG. 7 schematically illustrates a schematic diagram of a backscattering cross section of a metastable helium peak and a normalized intensity of an echo signal according to the embodiments of the present disclosure.

FIG. 8 schematically illustrates a flow chart of a determination method for parameters of a Fizeau interferometer according to the embodiments of the present disclosure.

FIG. 9 schematically illustrates a curve chart of relationships between different shape factors and a transmittance of the Fizeau interferometer according to the embodiments of the present disclosure.

FIG. 10 schematically illustrates a data processing flow chart according to the embodiments of the present disclosure.

FIG. 11 schematically illustrates a schematic diagram of a laser line shape detected by the detector, a total echo signal, and a convolution result of the Fizeau interferometer according to the embodiments of the present disclosure.

### DESCRIPTION OF REFERENCE SIGNS

1: First tunable continuous laser device;
2: First pulse laser device;
3: First wavelength meter;
4: Second tunable continuous laser device;
5: Second pulse laser device;
6: Second wavelength meter;
7: Telescope;
8: Optical switch;
9: Filter;
10: Fizeau interferometer;
11: Detector.

### DETAILED DESCRIPTION OF EMBODIMENTS

The embodiments of the present disclosure are further described below in conjunction with the accompanying drawings.

With the development of laser radar technology, the resonant fluorescence laser radar has gradually become one of the common means of thermosphere detection. Helium atoms are one of the main components of the atmosphere above 200 km. After physical processes such as photoelectron excitation, metastable helium [He(2³S)] that is more stable and has stronger fluorescence may be produced. Therefore, metastable helium may be used as one of the preferred tracers for ground-based laser radar to observe the neutral atmosphere in this altitude range. The principle of metastable helium resonance fluorescence laser radar for detecting atmospheric parameters is as follows: an emitting end of the laser radar emits a narrow linewidth laser beam with a wavelength of 1083 nm vertically upward to the sky to excite helium atoms in the thermosphere, making extranuclear electrons thereof to transition to a high energy level and de-excite to a lower energy level, i.e. a resonance fluorescence reaction occurs. On the ground, a telescope at a receiving end of the laser radar receives an echo signal, detects the number of echo photons using a photodetector, and performs a series of signal processing and data inversion to obtain the metastable helium density in the thermospheric layer. Meanwhile, by making a radar laser transmitter emit lasers with three frequencies alternately and through the relative relationship among the resonant fluorescence intensities excited by the three frequencies, the temperature and wind field of metastable helium within the detection altitude range may be obtained by inversion. In conjunction with the atmospheric model and based on some assumptions and boundary conditions, the density, temperature and wind field of the background atmosphere may be derived.

However, the laser radar detection technology for the metastable helium temperature and wind measurement may not be well implemented in the related technologies. The temperature and wind measurement means in the related technologies are generally limited to three-frequency temperature and wind measurement using sodium laser radar. In comparison, helium laser radar has a higher detection altitude and weaker signals. In order to achieve the temperature and wind measurement function of helium laser radar, a more optimized method needs to be developed, thereby achieving a higher signal-to-noise ratio, and thus obtaining more accurate temperature and wind field measurement results.

On this basis, the present disclosure provides a dual-frequency temperature and wind measurement system for a helium laser radar based on a Fizeau interferometer. Dual-frequency temperature and wind measurement may be achieved by introducing at least two laser devices into an emitting system, introducing a new-typed Fizeau interferometer into a receiving system and collecting metastable helium scattering information in an area to be measured. This not only overcomes the technical defects in the related technologies, but also provides a new research direction for the subsequent study of temperature and wind measurement.

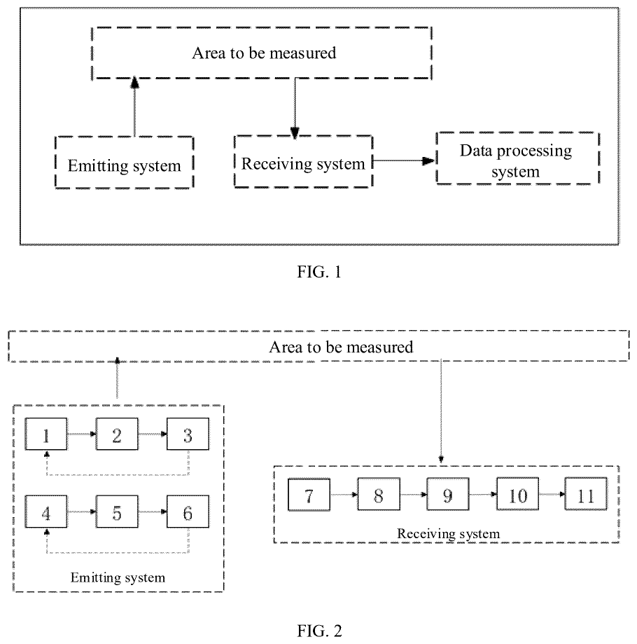

FIG. 1 schematically illustrates a block diagram of a dual-frequency temperature and wind measurement system for a helium laser radar based on a Fizeau interferometer according to the embodiments of the present disclosure.

As illustrated in FIG. 1, the dual-frequency temperature and wind measurement system for a helium laser radar based on a Fizeau interferometer includes an emitting system, a receiving system and a data processing system.

FIG. 2 schematically illustrates a schematic diagram of the dual-frequency temperature and wind measurement system for a helium laser radar based on a Fizeau interferometer according to the embodiments of the present disclosure.

According to the exemplary embodiments of the present disclosure, the present disclosure discloses a dual-frequency temperature and wind measurement system for a helium laser radar based on a Fizeau interferometer. Referring to FIG. 2, the emitting system includes at least two laser devices configured to emit pulsed lasers with different frequencies to an area to be measured. The receiving system includes a telescope 7, an optical switch 8, a Fizeau interferometer 10, and a detector 11. The telescope 7 is configured to receive an echo signal having metastable helium scattering information from the area to be measured, the filter 9 is configured to perform a first-stage filtering process on the echo signal having metastable helium scattering information received by the telescope 7, the Fizeau interferometer 10 is configured to perform a second-stage filtering process on the echo signal having metastable helium scattering information processed by the filter 9, and the detector 11 is configured to receive a scattering echo signal processed by the Fizeau interferometer 10, in which an echo signal processed by the Fizeau interferometer 10 is represented by a measurement spectrum, and the measurement spectrum is a convolution of a scattering spectrum and a transmittance function of the Fizeau interferometer 10. The data processing system is configured to process the echo signal received by the detector 11 to obtain a wind speed and temperature of the area to be measured. The wind speed and temperature of the area to be measured are determined according to a result of a linear interpolation comparison between an echo signal spectrum of the lasers and an echo signal spectrum library obtained by simulation, and the echo signal spectrum of the lasers is a deconvolution of the measurement spectrum and the transmittance function of the Fizeau interferometer 10.

According to the embodiments of the present disclosure, by introducing at least two laser devices in the emitting system, two pulsed lasers with different frequencies are ensured to be emitted simultaneously. This overcomes the defects caused by the temperature and wind measurement method by which three frequencies are switched alternately and lasers with three frequencies are emitted using three laser devices in the related technologies. This dual-frequency emitting system may not only save the time of traditional alternate laser emission, but may also reduce the complexity and maintenance difficulty of a laser radar.

According to the embodiments of the present disclosure, by reforming some modules, i.e., introducing a new-typed Fizeau interferometer 10 into the receiving system to replace the traditional F—P etalon, linear fringes that may replace annular fringes may be generated, and the position and shape changes of linear fringes may be detected directly with a linear detector 11 without frequency scanning. The new-typed receiving system may not only save the frequency scanning time and accumulate photon signals continuously, but also greatly simplify the data processing method.

According to the embodiments of the present disclosure, helium atoms are one of the main atmospheric components above 200 km. After physical processes such as photoelectron excitation, metastable helium [He(2³S)] that is more stable and has stronger fluorescence may be produced. Therefore, compared with the temperature and wind measurement using sodium resonance fluorescence laser radar in the related technologies, the temperature and wind measurement by collecting metastable helium scattering information in the area to be measured may provide a new research direction for subsequent researches on temperature and wind measurement, and also fill the theoretical gap in the helium laser radar for temperature and wind measurement. Therefore, this enables a more comprehensive observation and research on the thermospheric atmospheric physical processes and multi-sphere coupling mechanisms.

According to the embodiments of the present disclosure, the at least two laser devices included in the emitting system includes: a first tunable continuous laser device 1, a first pulse laser device 2, a second tunable continuous laser device 4, and a second pulse laser device 5. The first tunable continuous laser device and the second tunable continuous laser device 4 are configured to generate stable and continuous seed lasers with a wavelength around 1083 nm. The first pulse laser device 2 and the second pulse laser device 5 are configured to perform an optical amplification on the seed lasers and emit the seed lasers to the area to be measured. The first pulse laser device 2 and the second pulse laser device 5 respectively transmit a part of the emitted lasers after the optical amplification to a first wavelength meter 3 and a second wavelength meter 6 to monitor frequencies of the emitted lasers in real time using the first wavelength meter and the second wavelength meter, and feedback the frequencies to the first tunable continuous laser device 1 and the second tunable continuous laser device 4 to achieve frequency locking of the emitted lasers.

According to the embodiments of the present disclosure, the first tunable continuous laser device 1 and the second tunable continuous laser device 4 are the same in structure, the first pulse laser device 2 and the second pulse laser device 5 are the same in structure, and the first wavelength meter 3 and the second wavelength meter 6 are the same in structure.

According to the embodiments of the present disclosure, the first pulse laser device 2 and the second pulse laser device 5 are solid ytterbium-doped yttrium aluminum garnet crystal (Yb:YAG) pulse laser devices, and may output pulsed light near 1083 nm and emit it vertically upward to the area to be measured.

According to the embodiments of the present disclosure, helium atoms have two sets of energy levels, singlet energy level and triplet energy level, with no transition therebetween. In the singlet energy level, helium has the first excited state of 2¹S₀ and a lifetime of about 19.5 ms. In the triplet energy level, helium has the first excited state of 2³S₁, which contains three radiation lines of 1082.909 nm, 1083.025 nm and 1083.034 nm, and under ideal conditions, helium (2³S₁) has a natural lifetime of about 8000 s, and is suitable as a tracer for detecting the temperature and wind speed of the thermosphere.

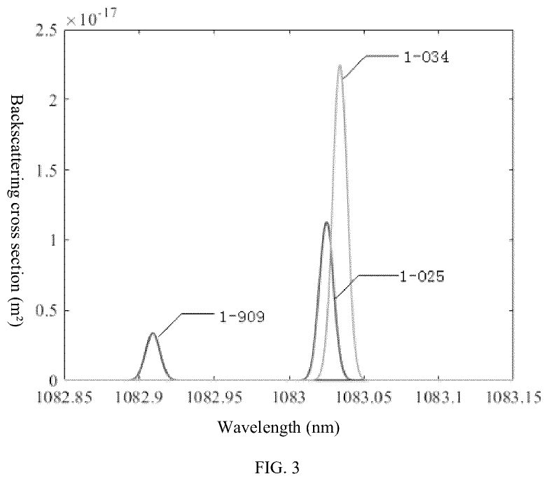

FIG. 3 schematically illustrates curve charts of backscattering cross sections of metastable helium corresponding to three radiation lines around 1083 nm changing with wavelength according to the embodiments of the present disclosure.

As illustrated in FIG. 3, curves 1-909, 1-025 and 1-034 respectively represent backscattering cross sections corresponding to three radiation lines of metastable helium at 1082.909 nm, 1082.025 nm and 1082.034 nm. In contrast, the radiation line of metastable helium at 1082.909 nm is seriously interfered by hydroxyl groups. Therefore, in the present application, two radiation lines corresponding to wavelengths of 1083.025 nm and 1083.034 nm are selected for observation.

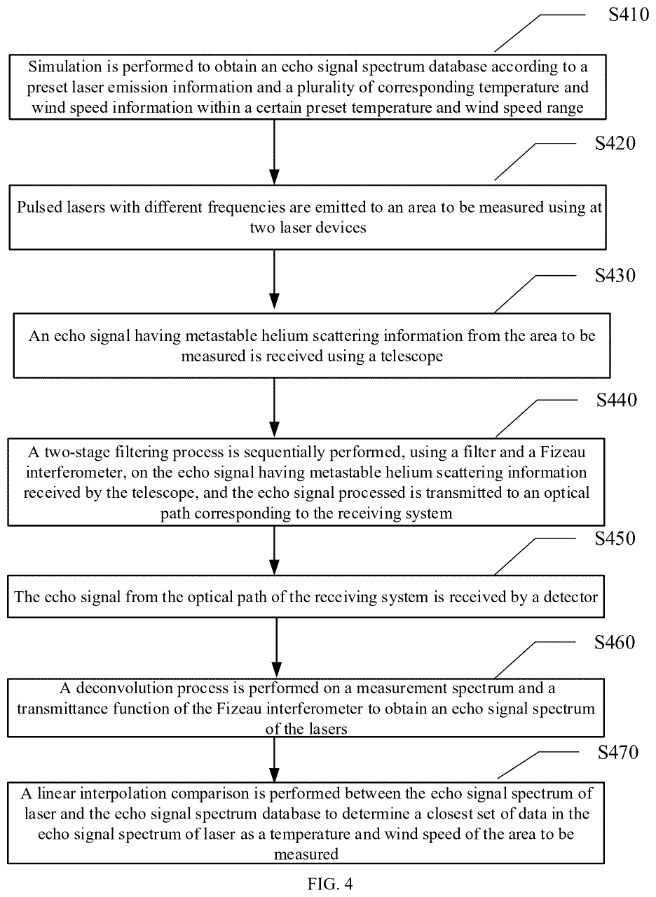

FIG. 4 schematically illustrates a flow chart of a dual-frequency temperature and wind measurement method for a helium laser radar based on a Fizeau interferometer according to embodiments of the present disclosure.

As illustrated in FIG. 4, the dual-frequency temperature and wind measurement method for a helium laser radar based on a Fizeau interferometer may include operation S410 to operation S470.

In operation S410, simulation is performed to obtain an echo signal spectrum database according to a preset laser emission information and a plurality of corresponding temperature and wind speed information within a certain preset temperature and wind speed range. The preset laser emission information is frequency information of lasers to be emitted corresponding to at least two laser devices.

According to the embodiments of the present disclosure, the velocity distribution of helium atoms obeys Maxwell distribution law, and the statistical average absorption cross section of each helium atom is obtained by calculation through formula (I):

$${σ}_{abs} = \frac{1}{\sqrt{2 π} {σ}_{D}} \frac{{λ}^{2}}{8 π} \frac{{g}_{k}}{{g}_{i}} {A}_{ki} exp [ - \frac{{( v - {v}_{0} - w / λ )}^{2}}{2 {σ}_{D}^{2}} ] . \qquad ( I )$$

In formula (1), in the Doppler absorption cross section

$${σ}_{D} = {v}_{0} \sqrt{\frac{{k}_{B} T}{{Mc}^{2}}} ,$$

ν represents a laser frequency, ν₀ represents a resonance frequency of each helium atom transition line, w represents a radial wind speed, λ represents a laser wavelength, i represents a lower energy level, k represents a higher energy level, gᵢ and gₖ are respectively degradation factors of the lower energy level and the higher energy level, Aₖᵢ represents a transition probability from a k energy level to an i energy level, i.e., the Einstein coefficient (S⁻¹), k_{B} represents the Boltzmann constant, T represents an atomic temperature, M represents an atomic mass, and c represents a speed of light. When the radial wind speed is negative, it means that the wind direction is close to the radar. When the radial wind speed is positive, it means that the wind direction is far away from the radar.

It is assumed that the number of all emitted photons is equal to the number of absorbed photons, the effective cross section is obtained by calculation through formula (II):

σ_{eff}(ν,ν₀)=σ_{abs}(ν,ν₀) (II).

In formula (II), σ_{eff} represents an effective cross section of each helium atom, σ_{abs} represents a statistical average absorption cross section of each helium atom, ν₀ represents a resonant frequency of each helium atom transition line, and ν represents a laser frequency.

According to the embodiments of the present disclosure, under different thermospheric temperatures and wind speeds, the backscattering cross section of metastable helium at the 1083 nm peak will change, thereby affecting the relative intensity of the echo signal. The corresponding effective scattering cross section spectrum may be obtained by changing the temperature and wind speed.

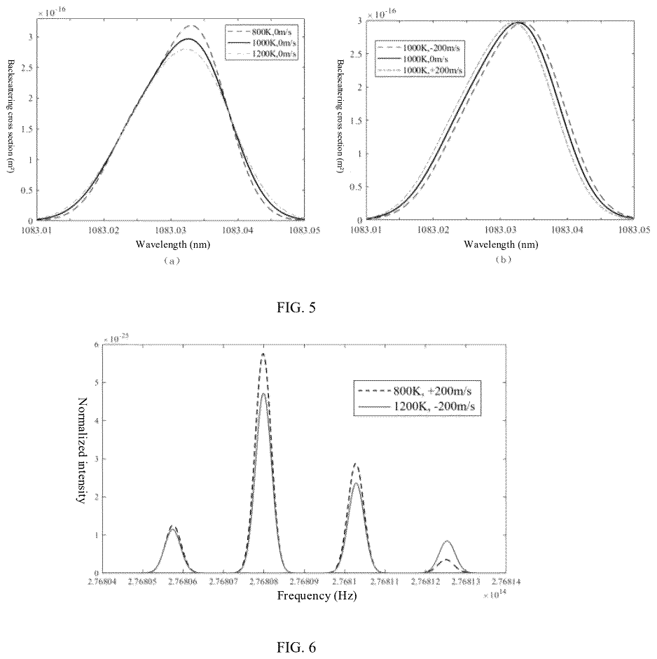

FIG. 5 schematically illustrates curve charts of backscattering cross sections changing with temperature and wind speed according to the embodiments of the present disclosure.

FIG. 5 plots backscattering cross sections at different temperatures and wind speeds. FIG. 5(a) illustrates the backscattering cross sections respectively corresponding to the temperatures of 800 K, 1000 K and 1200 K when the radial wind speed is 0 m/s. It may be found that with the increase of temperature, due to Doppler broadening, the full width at half maximum increases, the peak intensity decreases, and the maximum position of the main peak at 1083 nm gradually moves toward the shortwave direction. FIG. 5(b) illustrates the backscattering cross sections respectively corresponding to the radial wind speeds of −200 m/s, 0 m/s and +200 m/s when the temperature is 1000 K. If the wind speed is positive, the wind direction is the direction of the atmosphere pointing to the radar, and the spectral lines generally move toward the shortwave direction. If the wind speed is negative, the wind direction is the direction of the atmosphere far away from the radar, and the spectral lines generally move toward the longwave direction.

Within the temperature range of 700K to 2000K and the wind speed range of −200 m/s to +200 m/s, the temperature and wind speed are scaled to 0.1K and 0.1 m/s to obtain the metastable helium scattering cross sections at different temperatures and wind speeds. In conjunction with the frequency information corresponding to the two lasers to be emitted, each group of scattering cross section information uniquely corresponding to different temperatures and wind speeds forms a data set, i.e., an echo signal spectrum database corresponding to a specific temperature and wind speed may be obtained by simulation.

FIG. 6 schematically illustrates two groups of data examples in an echo signal spectrum database according to the embodiments of the present disclosure.

As illustrated in FIG. 6, the dotted line represents the echo signal at (800K, +200 m/s), and the solid line represents the echo signal at (1200K, −200 m/s). It may be found that under different temperatures and wind speeds, the two groups of echo linear shapes are different, i.e., each group of echo linear shape corresponds to a specific temperature and wind speed.

In operation S420, pulsed lasers with different frequencies are emitted to an area to be measured using at least two laser devices.

According to the embodiments of the present disclosure, the operation of emitting, using at least two laser devices, pulsed lasers with different frequencies to an area to be measured includes: generating stable and continuous seed lasers with a wavelength around 1083 nm using the first tunable continuous laser device 1 and the second tunable continuous laser device 4; and performing an optical amplification on the seed lasers and emitting the seed lasers vertically upward to the area to be measured using the first pulse laser device 2 and the second pulse laser device 5. After the optical amplification is performed on the seed lasers using the first pulse laser device 2 and the second pulse laser device 5, frequencies of a part of the emitted lasers received are monitored in real time using the first wavelength meter 3 and the second wavelength meter 6, and fed back to the first tunable continuous laser device 1 and the second tunable continuous laser device 4 to achieve frequency locking of the emitted lasers.

In operation S430, the echo signal having metastable helium scattering information from the area to be measured is received using the telescope 7.

According to the embodiments of the present disclosure, the at least two laser devices simultaneously emit two pulsed lasers with different frequencies to the area to be measured, so that four echo signals having metastable helium scattering information of different frequencies may be received by the telescope 7.

According to the embodiments of the present disclosure, it is assumed that the velocity distribution of atoms obeys Maxwell distribution law, due to the Doppler effect of electromagnetic waves, the pulsed laser device emits lasers to cause resonant fluorescence scattering of helium atoms in the thermosphere atmosphere. Echo signals with two frequencies may be obtained by emitting one laser, and the two echo signals are symmetrical with the frequencies respectively corresponding to 1083.025 nm and 1083.034 nm in the frequency domain, and have the intensities related to the backscattering cross section of metastable helium total peak at 1083 nm. Under different thermospheric temperatures and wind speeds, the backscattering cross section of metastable helium at 1083 nm will change, resulting in a different intensity and frequency of the echo signal.

It should be noted that when the temperature and wind speed are inverted based on echo signals, if only one laser is emitted, the amount of information contained is too little and the error is too large. Therefore, at least two lasers need to be emitted to obtain echo signals at four frequencies.

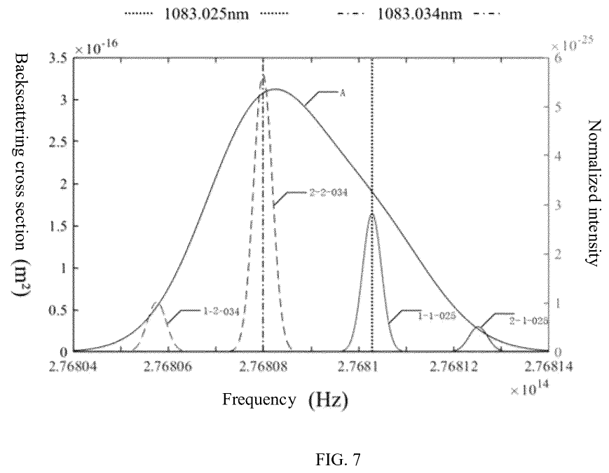

FIG. 7 schematically illustrates a schematic diagram of a backscattering cross section of a metastable helium peak and a normalized intensity of an echo signal according to the embodiments of the present disclosure.

As illustrated in FIG. 7, the black dotted line and the black dot-dashed line respectively represent the wavelengths corresponding to 1083.025 nm and 1083.034 nm, curve A represents the combined peak of metastable helium at 1083 nm, curve 1-1-025 represents the first echo signal corresponding to the laser emitted by the first pulse laser device 2, curve 1-2-034 represents the second echo signal corresponding to the laser emitted by the first pulse laser device 2, curve 2-1-025 represents the first echo signal corresponding to the laser emitted by the second pulse laser device 5, and curve 2-2-034 represents the second echo signal corresponding to the laser emitted by the second pulse laser device 5. It may be found that the backscattering cross section and intensity corresponding to the echo signal close to the peak value of the combined peak of metastable helium at 1083 nm are higher, and the backscattering cross section and intensity corresponding to the echo signal far from the peak value of the combined peak of metastable helium at 1083 nm are lower.

According to the embodiments of the present disclosure, the laser radar signal received by the telescope 7 may express a set of effects of the atmosphere on scattering, absorption, etc. of the laser beam. By using the echo signals of thermospheric helium atoms, a connection may be established between the number of photons received by the receiving system and the system parameters to invert the corresponding temperature and wind speed of the thermospheric atmosphere. Let P represent the power of the two pulsed laser devices, A represent the aperture of the telescope 7, and η represent the total optical efficiency of the receiving system. Then, the resonance fluorescence laser radar equation may be expressed by formula (III) as follows:

$$N ( z ) = \frac{P {τλ}_{0}}{{h}_{0} c} \times [ {σ}_{eff} ρ ( z ) R Δ z ] \times \frac{A}{4 π {z}^{2}} \times [ η {T}^{2} {E}^{2} ( z ) ] + {N}_{B} \times τ . \qquad ( III )$$

In formula (III), z represents the measurement height, Δz represents the spatial resolution of the measurement, N(z) represents the total number of photons collected between z-Δz/2 and z+Δz/2; t is the integration time(s); h₀ is the Planck constant, h≈6.62607015×10⁻³⁴ J·s; c is the speed of light, c≈299792458 m/s; σ_{eff} represents the effective cross section of each helium atom, λ₀ is the central wavelength of the emitted laser; ρ(z) is the number density of metastable helium; R is the branching ratio; T is the one-way transmittance of the atmosphere; E(z) is the one-way extinction ratio of the atmosphere; N_{B}×τ represents the number of photons caused by background radiation and dark current, which is related to the zenith angle SZA.

Let h represent the height of the bottom metastable helium atom, then the one-way extinction ratio E(z) of the atmosphere may be expressed by formula (IV) as follows:

$$E ( z ) = exp [ - {\int }_{h}^{z} {σ}_{eff} ρ ( z ) dz ] . \qquad ( IV )$$

In formula (IV), z represents the measurement height; ρ(z) is the number density of metastable helium; σ_{eff} represents the effective cross section of each helium atom. It may be found that the number of photons received by the telescope 7 is directly proportional to the number of photons emitted, the aperture of the telescope 7 and the system efficiency.

According to the embodiments of the present disclosure, after the relationship is determined between the two frequencies of the laser to be emitted and the temperature and wind speed of the thermosphere through formulas (1) and (2), an echo signal spectrum database may be established, in which each group of echo linear shape corresponds to a specific temperature and wind speed. According to the simulated echo signal spectrum database, a plurality of parameters of the Fizeau interferometer 10 may be determined.

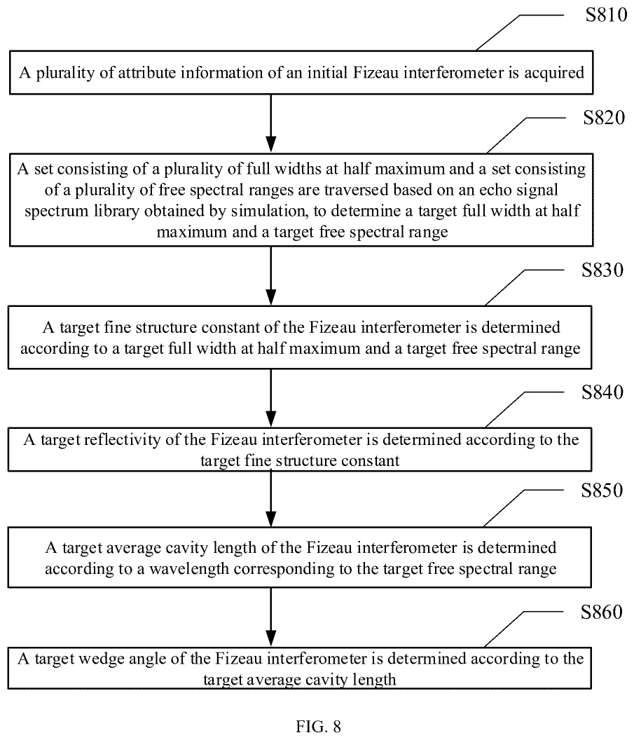

FIG. 8 schematically illustrates a flow chart of a determination method for parameters of a Fizeau interferometer according to the embodiments of the present disclosure.

As illustrated in FIG. 8, the determination method for parameters of a Fizeau interferometer may include operations S810 to S860.

In operation S810, a plurality of attribute information of an initial Fizeau interferometer is acquired. The plurality of attribute information includes: a set consisting of a plurality of full widths at half maximum of the initial Fizeau interferometer, a set consisting of a plurality of free spectral ranges, and an angle of incidence of the echo signal having metastable helium scattering information processed by the filter to the initial Fizeau interferometer.

According to the embodiments of the present disclosure, the initial Fizeau interferometer consists of a beam splitter, a collimating objective lens and a standard plane. It is assumed that a very narrow segment Δy is selected at the center of the initial Fizeau interferometer, the initial Fizeau interferometer here may be regarded as a traditional F—P etalon. At the center position, the transmittance function of the initial Fizeau interferometer is expressed by formula (V) as follows:

$$T ( v ) = \frac{{T}_{P}}{1 + \frac{4 {F}^{2}}{{π}^{2}} {sin}^{2} [ \frac{π ( v - {v}_{0} )}{FSR} ]} . \qquad ( V )$$

In formula (V), T_{P} represents the peak transmittance of the Fizeau interferometer; ν₀ represents the center frequency of the transmittance of the Fizeau interferometer; ν represents the laser frequency; F represents the target fine structure constant of the Fizeau interferometer; and F represents the target free spectral range.

When the backscattering signal spectrum is obtained using the initial Fizeau interferometer, the interval of the spectral frequency range should be within the receiving range of the initial Fizeau interferometer to ensure that the complete spectral pattern is received by the linear detector 11. In order to reduce the error caused by photon loss, most of the energy of the scattering spectrum corresponding to each echo signal is concentrated within one full width at half maximum (FWHM), and the free spectral range (FSR) needs to be controlled so that the transmittance curve in the scattering spectrum includes all echo signals as much as possible.

In operation S820, the set consisting of a plurality of full widths at half maximum and the set consisting of a plurality of free spectral ranges are traversed based on the echo signal spectrum library obtained by simulation, to determine a target full width at half maximum and a target free spectral range.

According to the embodiments of the present disclosure, in conjunction with the echo signal spectrum database obtained by passive simulation and the scattering information of the echo signal, one subset that best matches the scattering spectrum curve of echo signal is selected from the set consisting of a plurality of full widths at half maximum and the set consisting of a plurality of free spectral ranges as the target full width at half maximum and the target free spectral range. Preferably, the target full width at half maximum is 0.005 nm, and the target free spectral range is 0.01 nm.

In operation S830, a target fine structure constant of the Fizeau interferometer 10 is determined according to the target full width at half maximum and the target free spectral range.

In operation S840, a target reflectivity of the Fizeau interferometer 10 is determined according to the target fine structure constant.

According to the embodiments of the present disclosure, a high finesse will improve the resolution of the Fizeau interferometer 10, but will also bring difficulties in processing. Therefore, in order to select an appropriate fineness, it not only needs to consider improving the resolution of the Fizeau interferometer 10, but also needs to consider facilitating subsequent processing.

The target fine structure constant and the target reflectivity of the Fizeau interferometer 10 are determined by formula (VI) as follows:

$$F = \frac{FSR}{FWHM} = \frac{π \sqrt{R}}{1 - R} . \qquad ( VI )$$

In formula (VI), F represents the target fine structure constant of the Fizeau interferometer 10, FSR represents the target free spectral range, FWHM represents the target full width at half maximum, and R represents the target reflectivity of the Fizeau interferometer 10.

According to the embodiments of the present disclosure, when the target full width at half maximum and the target free spectral range are known, the target fine structure constant F=2 and the target reflectivity R=0.24 of the Fizeau interferometer 10 may be obtained.

In operation S850, a target average cavity length of the Fizeau interferometer 10 is determined according to a wavelength corresponding to the target free spectral range.

In operation S860, a target wedge angle of the Fizeau interferometer 10 is determined according to the target average cavity length. The target wedge angle is an included angle between two flat plates of the Fizeau interferometer 10, and the target wedge angle is used to adjust a width of an interference fringe of the Fizeau interferometer 10.

According to the embodiments of the present disclosure, it is assumed that monochromatic parallel light is incident at an angle θ onto two flat plates with a high reflectivity and an included angle α, a portion of the light passes directly through the two plates, and the other portion of the light is reflected between the two plates for many times and then exits. The two portions of light have an included angle of 2nα (n is the refractive index of the medium), they are coherent and produce fringes of equal thickness. The beam splitter and the collimating objective lens together with the two flat plates with a high reflectivity constitute an initial Fizeau interferometer.

According to the embodiments of the present disclosure, the transmittance of the Fizeau interferometer is related to the spatial position of the incident light beam on the wedge of the Fizeau interferometer. Therefore, there will be different transmittance curves at different positions of the incident lasers. It is assumed that the light beam received by the telescope 7 vertically enters the Fizeau interferometer 10, when the target average cavity length of the Fizeau interferometer 10 is calculated, the narrow range at the center of the initial Fizeau interferometer may regarded as a traditional F—P etalon, and the target average cavity length of the Fizeau interferometer 10 may be calculated by using the relationship between the free spectral range and the average cavity length of the traditional F—P etalon. Additionally, the target wedge angle determines the width of the interference fringes.

The target average cavity length and the target wedge angle of the Fizeau interferometer 10 are determined by formula (VII) as follows:

$${L}_{0} = \frac{{λ}^{2}}{2 n {λ}_{FSR}} = \frac{λ}{2 α} . \qquad ( VII )$$

In formula (VII), L₀ represents the target average cavity length of the Fizeau interferometer 10, n represents the refractive index of the medium, λ represents the wavelength of the emitted laser, λ_{FSR} represents the wavelength corresponding to the target free spectral range, and a represents the target wedge angle of the Fizeau interferometer 10.

When the wavelength of the emitted laser is 1083 nm and the refractive index of the medium in the wedge-shaped space is 1, the target average cavity length L₀ may be calculated to be about 0.06 m according to the wavelength corresponding to the target free spectral range. Moreover, when it is known that the echo signal is vertically incident on the initial Fizeau interferometer, the target wedge angle of the Fizeau interferometer 10 may also be calculated to be 9.2 μrad.

According to the embodiments of the present disclosure, the shape factor will affect the shape of the interference fringes, and different shape factors correspond to different transmittance curves of the Fizeau interferometer 10. Therefore, the rationality of various parameters corresponding to the Fizeau interferometer 10 may be verified by the shape factor.

According to the embodiments of the present disclosure, the shape factor is determined by formula (VIII) as follows:

$$S = {( 2 \frac{{L}_{0} v}{c} {α}^{2} )}^{1 / 3} \times F . \qquad ( VIII )$$

In formula (VIII), S represents the shape factor, F represents the target fine structure constant of the Fizeau interferometer 10, L₀ represents the target average cavity length of the Fizeau interferometer 10, α represents the target wedge angle of the Fizeau interferometer 10, ν represents the laser frequency, and c represents the speed of light.

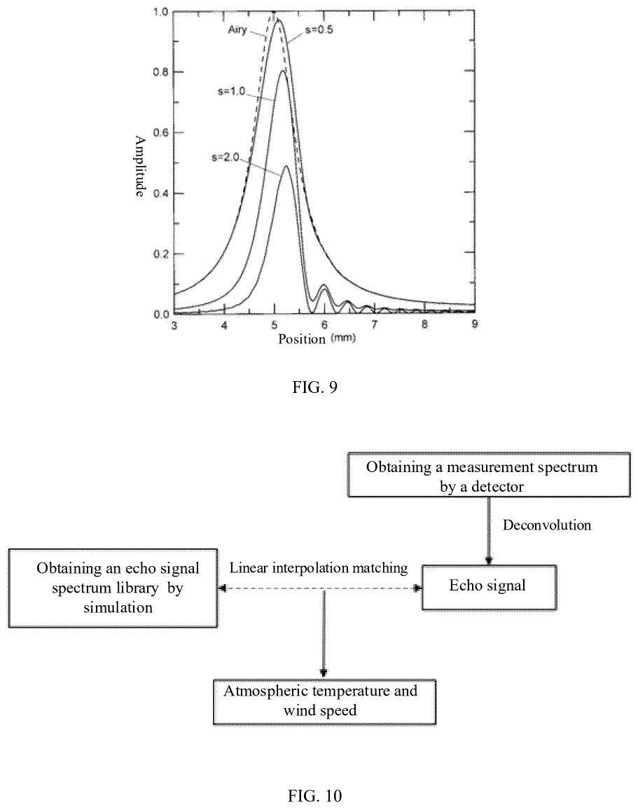

FIG. 9 schematically illustrates a curve chart of relationships between different shape factors and a transmittance of the Fizeau interferometer 10 according to the embodiments of the present disclosure.

As illustrated in FIG. 9, in conjunction with formula (VIII), when the shape factor is less than 0.6, the transmittance curve of the Fizeau interferometer 10 may be approximated as an Airy function, and then the wind speed may be inverted by the Airy function. If S≤0.6 is obtained by calculation, the vertical incidence state of the incident angle θ=0 may be maintained. If S>0.6 is obtained by calculation, the interference fringes need to be adjusted by adjusting the incident angle until S≤0.6. Various parameter values of the Fizeau interferometer 10 are substituted into the formula, S obtained by calculation meets the requirements.

According to the embodiments of the present disclosure, the rationality of various parameters corresponding to the Fizeau interferometer 10 may also be verified by the resolution of the Fizeau interferometer 10.

By using Taylor criterion, the resolution of the Fizeau interferometer 10 is determined by formula (IX) as follows:

$$RP = \frac{λ}{Δλ} = m π \frac{\sqrt{R}}{1 - R} . \qquad ( IX )$$

$$Let m = \frac{2 {L}_{0}}{λ} , and Δλ = \frac{{λ}^{2}}{c} Δ v ,$$

formula (IX) may be further expressed as follows:

$$RP = \frac{λ}{Δλ} = \frac{c}{λΔ v} = \frac{2 π {L}_{0}}{λ} \frac{\sqrt{R}}{1 - R} = \frac{2 {L}_{0} F}{λ}$$

$$Δ v = \frac{c}{2 {L}_{0} F}$$

In formula (IX), Δν represents the minimum frequency range that the Fizeau interferometer 10 may resolve, m represents the resolution series, and Δλ represents the minimum wavelength range that the Fizeau interferometer 10 may resolve. In conjunction with the average cavity length L₀ and the target fine structure constant F calculated in the preceding text, it may be further obtained that the frequency resolution of the Fizeau interferometer 10 is about 1.28 GHz. In the related technologies, the minimum frequency interval between two metastable He echo signals is 2.23 GHz. Thereby, it may be known that the various parameter values in the preceding text may meet the requirements for distinguishing four echo signals.

In operation S440, a two-stage filtering process is sequentially performed, using the filter 9 and the Fizeau interferometer 10, on the echo signal having metastable helium scattering information received by the telescope 7, and the echo signal processed is transmitted to an optical path corresponding to the receiving system.

According to the embodiments of the present disclosure, the first-stage filtering process is performed, using the filter 9, on the echo signal having metastable helium scattering information received by the telescope 7, and the second-stage filtering process is performed, using an ultra-narrow band Fizeau interferometer 10, on the echo signal having metastable helium scattering information processed by the filter 9. The echo signal having metastable helium scattering information processed by the filter 9 undergoes equal-thickness interference in the ultra-narrow band Fizeau interferometer 10, and parallel light beams of the echo signal after the equal-thickness interference are classified according to different frequencies and transmitted to the optical path corresponding to the receiving system.

FIG. 10 schematically illustrates a data processing flow chart according to the embodiments of the present disclosure.

As illustrated in FIG. 10, the data processing flow includes step S450 to step S470.

In operation S450, the echo signal from the optical path of the receiving system is received by the detector 11. The echo signal in the optical path of the receiving system is represented by a measurement spectrum, and the measurement spectrum is a convolution of a scattering spectrum and a transmittance function of the Fizeau interferometer 10.

The measurement spectrum may be determined by formula (X) as follows:

S_{conv}=S_{scatter}⊗S_{Fizeau} (X)

In formula (X), S_{conv} represents the measurement spectrum, S_{scatter} represents the scattering spectrum, and S_{Fizeau} represents the transmittance function of the Fizeau interferometer.

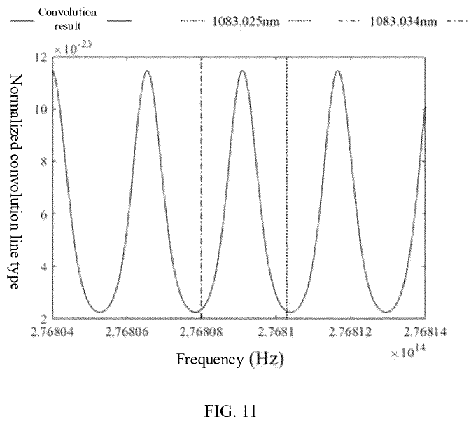

FIG. 11 schematically illustrates a schematic diagram of a laser line shape detected by the detector, a total echo signal, and a convolution result of the Fizeau interferometer according to the embodiments of the present disclosure.

As illustrated in FIG. 11, it is assumed that the laser emitted by the laser radar system is a Gaussian line shape, the line width is 200 MHz, the temperature is 850K, and the wind speed is 0 m/s. When the laser line shape is known, the convolution result of the scattering spectrum and the transmittance function of the Fizeau interferometer 10 may be obtained according to the number of photons received by each channel of the detector 11.

In operation S460, a deconvolution process is performed on the measurement spectrum and the transmittance function of the Fizeau interferometer (10) to obtain an echo signal spectrum of the lasers.

In operation S470, a linear interpolation comparison is performed between the echo signal spectrum of the lasers and the echo signal spectrum database to determine a closest set of data in the echo signal spectrum of the lasers as a temperature and wind speed of the area to be measured. The area to be measured is the thermosphere atmosphere.

According to the embodiments of the present disclosure, in the dual-frequency temperature and wind measurement method for a helium laser radar based on a Fizeau interferometer, at least two laser devices are introduced at the emitting end and some modules are reformed at the receiving end. On the one hand, this may save the time of traditional alternate laser emission, and may also reduce the complexity and maintenance difficulty of the laser radar. On the other hand, this may save the frequency scanning time, continuously accumulate photon signals, and greatly simplify the data processing method. Finally, metastable helium scattering information is collected in the area to be measured for temperature and wind measurement. This may provide a new research direction for subsequent researches on temperature and wind measurement, and also fill the theoretical gap in the helium laser radar for temperature and wind measurement, thereby enabling a more comprehensive observation and research on the thermospheric atmospheric physical processes and multi-sphere coupling mechanisms.

The above specific implementations of the present disclosure do not constitute a limitation on the protection scope of the present disclosure. Any other corresponding modifications and variations made according to the technical concept of the present disclosure should be included in the protection scope of the claims of the present disclosure.

1. A dual-frequency temperature and wind measurement system for a helium laser radar based on a Fizeau interferometer, comprising:
an emitting system, comprising:
at least two laser devices configured to emit pulsed lasers with different frequencies to an area to be measured;
a receiving system, comprising:
a telescope (7) configured to receive an echo signal having metastable helium scattering information from the area to be measured;
a filter (9) configured to perform a first-stage filtering process on the echo signal having metastable helium scattering information received by the telescope (7);
a Fizeau interferometer (10) configured to perform a second-stage filtering process on the echo signal having metastable helium scattering information processed by the filter (9); and
a detector (11) configured to receive a scattering echo signal processed by the Fizeau interferometer (10), wherein the echo signal processed by the Fizeau interferometer (10) is represented by a measurement spectrum, and the measurement spectrum is a convolution of a scattering spectrum and a transmittance function of the Fizeau interferometer (10); and
a data processing system configured to process the echo signal received by the detector (11) to obtain a wind speed and temperature of the area to be measured, wherein the wind speed and temperature of the area to be measured are determined according to a result of a linear interpolation comparison between an echo signal spectrum of the lasers and an echo signal spectrum library obtained by simulation, and the echo signal spectrum of the lasers is a deconvolution of the measurement spectrum and the transmittance function of the Fizeau interferometer (10).

2. The system of claim 1, wherein the at least two laser devices comprised in the emitting system comprises:
a first tunable continuous laser device (1) and a second tunable continuous laser device (4) configured to generate stable and continuous seed lasers; and
a first pulse laser device (2) and a second pulse laser device (5) configured to perform an optical amplification on the seed lasers and emit the seed lasers to the area to be measured;
wherein the first pulse laser device (2) and the second pulse laser device (5) transmit a part of the emitted lasers after the optical amplification to a first wavelength meter (3) and a second wavelength meter (6) to monitor frequencies of the emitted lasers in real time, and feedback the frequencies to the first tunable continuous laser device (1) and the second tunable continuous laser device (4) to achieve frequency locking of the emitted lasers.

3. The system according to claim 2, wherein the first tunable continuous laser device (1) and the second tunable continuous laser device (4) are the same in structure, the first pulse laser device (2) and the second pulse laser device (5) are the same in structure, and the first wavelength meter (3) and the second wavelength meter (6) are the same in structure.

4. The system according to claim 1, wherein the at least two laser devices emit the lasers vertically upward.

5. A dual-frequency temperature and wind measurement method for a helium laser radar based on a Fizeau interferometer applied to the dual-frequency temperature and wind measurement system for a helium laser radar based on a Fizeau interferometer according to any one of claim 1, the method comprising:
performing simulation to obtain an echo signal spectrum database according to a preset laser emission information and a plurality of corresponding temperature and wind speed information within a certain preset temperature and wind speed range, wherein the preset laser emission information is frequency information of lasers to be emitted corresponding to the at least two laser devices;
simultaneously emitting, using the at least two laser devices, pulsed lasers with different frequencies to an area to be measured;
receiving, using the telescope (7), the echo signal having metastable helium scattering information from the area to be measured;
sequentially performing, using the filter (9) and the Fizeau interferometer (10), a two-stage filtering process on the echo signal having metastable helium scattering information received by the telescope (7), and transmitting the echo signal processed to an optical path corresponding to a receiving system;
receiving, by the detector (11), the echo signal from the optical path of the receiving system, wherein the echo signal in the optical path of the receiving system is represented by a measurement spectrum, and the measurement spectrum is a convolution of a scattering spectrum and a transmittance function of the Fizeau interferometer (10);
performing a deconvolution process on the measurement spectrum and the transmittance function of the Fizeau interferometer (10) to obtain an echo signal spectrum of the lasers; and
performing a linear interpolation comparison between the echo signal spectrum of the lasers and the echo signal spectrum database to determine a closest set of data in the echo signal spectrum of the lasers as a temperature and wind speed of the area to be measured.

6. The method according to claim 5, wherein the emitting, using the at least two laser devices, pulsed lasers with different frequencies to an area to be measured comprises:
generating the stable and continuous seed lasers using the first tunable continuous laser device (1) and the second tunable continuous laser device (4); and
performing an optical amplification on the seed lasers and emitting the seed lasers to the area to be measured using the first pulse laser device (2) and the second pulse laser device (5);
wherein after the optical amplification is performed on the seed lasers using the first pulse laser device (2) and the second pulse laser device (5), frequencies of a part of the emitted lasers received are monitored in real time using the first wavelength meter (3) and the second wavelength meter (6), and fed back to the first tunable continuous laser device (1) and the second tunable continuous laser device (4) to achieve frequency locking of the emitted lasers.

7. The method according to claim 6, wherein the at least two laser devices emit two pulsed lasers with different frequencies to the area to be measured, so that four echo signals having metastable helium scattering information of different frequencies are obtainable.

8. A determination method for parameters of a Fizeau interferometer applied to the dual-frequency temperature and wind measurement system for a helium laser radar based on a Fizeau interferometer according to claim 1, the method comprising:
acquiring a plurality of attribute information of an initial Fizeau interferometer (10), wherein the plurality of attribute information comprises: a set consisting of a plurality of full widths at half maximum of the initial Fizeau interferometer (10), a set consisting of a plurality of free spectral ranges, and an angle of incidence of the echo signal having metastable helium scattering information processed by the filter (9) to the initial Fizeau interferometer (10);
traversing the set consisting of a plurality of full widths at half maximum and the set consisting of a plurality of free spectral ranges based on the echo signal spectrum library obtained by simulation, to determine a target full width at half maximum and a target free spectral range;
determining a target fine structure constant of the Fizeau interferometer (10) according to the target full width at half maximum and the target free spectral range;
determining a target reflectivity of the Fizeau interferometer (10) according to the target fine structure constant;
determining a target average cavity length of the Fizeau interferometer (10) according to a wavelength corresponding to the target free spectral range; and
determining a target wedge angle of the Fizeau interferometer (10) according to the target average cavity length;
wherein the target wedge angle is an included angle between two flat plates of the Fizeau interferometer (10), and the target wedge angle is configured to adjust a width of an interference fringe of the Fizeau interferometer (10).

9. The determination method according to claim 8, wherein the target fine structure constant of the Fizeau interferometer (10) and the target reflectivity of the Fizeau interferometer (10) are obtained by calculation through formula (1);
$$F = \frac{FSR}{FWHM} = \frac{π \sqrt{R}}{1 - R} ; \qquad ( 1 )$$
wherein in formula (1), F represents the target fine structure constant of the Fizeau interferometer (10), FSR represents the target free spectral range, FWHM represents the target full width at half maximum, and R represents the target reflectivity of the Fizeau interferometer (10).

10. The determination method according to claim 8, wherein the target average cavity length and the target wedge angle of the Fizeau interferometer (10) are obtained by calculation through formula (2);
$${L}_{0} = \frac{{λ}^{2}}{2 n {λ}_{FSR}} = \frac{λ}{2 α} ; \qquad ( 2 )$$
wherein in formula (2), L₀ represents the target average cavity length of the Fizeau interferometer (10), n represents a refractive index of a medium, λ represents α wavelength of the emitted laser, λ_{FSR} represents the wavelength corresponding to the target free spectral range, and α represents the target wedge angle of the Fizeau interferometer (10).
